(19) United States
(12) Patent Application Publication
(10) Pub. No.: US 2020/0211117 A1
(43) Pub. Date: Jul. 2, 2020

(54) METHOD FOR DISPLAYING A HEAT MAP OF THE SEASONAL BREAKEVEN INFLATION CARRY OF INFLATION PROTECTED BONDS

(71) Applicant: ACTIUM LIQUIDITY PARTNERS, Boston, MA (US)

(72) Inventor: Athanassios George TOLIS, London (GB)

(73) Assignee: ACTIUM LIQUIDITY PARTNERS, Boston, MA (US)

(21) Appl. No.: 16/234,419

(22) Filed: Dec. 27, 2018

(51) Int. Cl. G06Q 40/06; G06F 17/24

(52) U.S. Cl. CPC G06Q 40/06; G06F 17/246

(57) ABSTRACT

A method for displaying a heat map of the seasonal breakeven inflation carry of inflation protected bonds comprising providing a spreadsheet of columns of carry values which have been seasonally adjusted according to the expected Consumer Price Index for rows of inflation protected bonds of different maturity dates, assigning color gradations within a first spectrum of colors to the carry values on a row by row basis for each bond and providing a first color to alternate rows, wherein the first color is in contrast to the colors of the first spectrum of colors.

### FIELD OF THE INVENTION

The present invention relates to the display of the seasonal breakeven inflation carry of inflation protected bonds and in particular to a heat map that is particularly clear and succinct for an investor.

### BACKGROUND OF THE INVENTION

Breakeven inflation is the difference between the yield to maturity of an inflation protected bond and the yield to maturity of its nominal comparator bond. Breakeven carry (a.k.a. breakeven inflation carry) is the change in breakeven inflation that arises mechanically from forward-pricing both bonds to a future settlement date as follows:

1. breakeven inflation is measured on the start date;

2. the bonds are both forward-priced using the same repo rate; in the case of the inflation-protected bond it is necessary to use a “reference CPI” index for that date, which may be known or may have to be estimated, depending on how distant in the future that date is; this estimate entails taking a view on the seasonality of the CPI inflation index;

3. the yield to maturity of each bond is measured on the forward date, based on the forward prices;

4. the breakeven inflation is measured at the forward settlement date (and is the difference between the yields to maturity that correspond to the prices on the forward settlement date); and

5. the change in breakeven inflation between the start date and the future settlement date is the breakeven carry.

Inflation protected bonds have been available for years and constitute an investment which is used to hedge against inflation. Two articles that discuss some of the theory behind these bonds are Introduction To Inflation-Protected Securities by Investopedia at https://www.investopedia.com/articles/04/091504.asp and which is hereby incorporated by reference and Introduction to Treasury Inflation-Protected Securities (TIPS), by Eric Petroff at https://www.investopedia.com/investing/introduction-treasury-inflation-protected-securities-tips/#axzz1RovBZV1x and which is hereby incorporated by reference.

### SUMMARY OF THE INVENTION

The main object of the present invention is to allow a user (a trader or salesperson or client investor) to view the “seasonal carry” of many securities in one page. It is a means of reflecting information succinctly and clearly. It allows the user to look at all bonds' carry on a relative rather than absolute scale. As a bonus, it also allows the user to not lose track visually of what bond he or she was looking at as they scan from left to right and back.

An ordinary heatmap for carry fails to convey seasonality information well. The reason the heatmap fails to convey the information well is that shorter-maturity bonds have a much more pronounced “seasonal carry.”

The advantages of the invention are that one can see the carry seasons clearly, the user's eye can float easily from left to right and one can get all the information one would get on an ordinary heatmap. Most of all, the invention allows potential users to scan and comprehend the information quicker.

These and other objects of the invention are achieved in accordance with the invention wherein a method for displaying a heatmap of the seasonal breakeven inflation carry of inflation protected bonds is provided comprising the steps of providing a spreadsheet of columns of carry values which have been seasonally adjusted according to the expected Consumer Price Index for rows of inflation protected bonds of different maturity dates, assigning color gradations within a first spectrum of colors to the carry values on a row by row basis for each bond, and providing a first color to alternate rows, wherein the first color is in contrast to the colors of the first spectrum of colors.

In another embodiment of the invention, the spreadsheet includes at least one entry in each column for each bond and wherein the at least one entry includes breakeven inflation carry estimates based on expected inflation estimates and which are in turn based on government generated inflation seasonality estimates. In further embodiments, the breakeven inflation carry is a monthly carry or the breakeven inflation carry is a cumulative carry. Alternatively, the seasonality estimates mentioned above can be private seasonality estimates rather than the government's seasonality estimates.

In an alternative embodiment, the spreadsheet includes at least two entries in each column for each bond and wherein one of the entries is breakeven inflation carry estimates based on expected inflation estimates and which are in turn based on government generated inflation seasonality estimates and another entry is calculated using an alternative inflation estimate. In further embodiments, the breakeven inflation carry is a monthly carry or the breakeven inflation carry is a cumulative carry. Alternatively, the seasonality estimates of the at least two entries mentioned above can both be private seasonality estimates rather than the government's seasonality estimates.

In still a further variation of the invention, the spreadsheet includes at least one entry in each column for each bond and wherein the at least one entry includes breakeven inflation carry based on an estimated CPI print estimate and which in turn are based on government generated inflation seasonality estimates.

In each of the embodiments, the first spectrum of colors preferably ranges from green to yellow to red. In a particularly preferred embodiment, the first color is white.

These and other embodiments of the present invention are achieved in accordance with the detailed description of the preferred embodiments and with reference to the attached drawings.

### BRIEF DESCRIPTION OF THE DRAWINGS

FIG. 1 shows a heatmap showing breakeven inflation carry of inflation protected bonds;

FIG. 2 shows an adjustment to the heatmap of FIG. 1 showing relative carry rather than absolute carry;

FIG. 3 shows an adjustment to the heatmap of FIG. 2 with alternate rows in a contrasting color;

FIG. 4 shows a monthly carry table in accordance with the invention; and

FIG. 5 shows a cumulative carry table in accordance with the invention.

### DETAILED DESCRIPTION OF THE PREFERRED EMBODIMENTS

The spreadsheets illustrated herein and which display the heatmap in accordance with the invention can be commercial spreadsheet software such as Microsoft Excel, Apple Numbers and other similar programs. The user apparatus for running this software or other specially made software can be embodied in a smartphone such as an iPhone or Android phone, can be embodied in a tablet such as an iPad or Android based tablet, a desktop computer such as a Windows PC or iMac, a laptop computer or a Chromebook.

The data for populating the spreadsheets can include a database formed from a variety of data stores and other memory or storage media. These components can reside in one or more of the servers, as discussed above, or may reside in a network of the servers. In certain embodiments, the information may reside in a storage-area network (SAN). Similarly, files for performing the functions attributed to the computers, servers or other network devices discussed above may be stored locally and/or remotely, as appropriate. Each computing system described above, may incorporate hardware elements that are electrically coupled via data/control/and power buses. For example, one or more processors in such computing systems may be central processing units (CPU). The user devices may further include at least one user device (e.g., a mouse, keyboard, controller, keypad, or touch-sensitive display) and at least one output device (e.g., a display, a printer or a speaker). Such user devices may also include one or more storage devices, including disk drives, optical storage devices and solid-state storage devices such as a random-access memory (RAM) or a read-only memory (ROM), as well as removable media devices, memory cards, flash cards, etc.

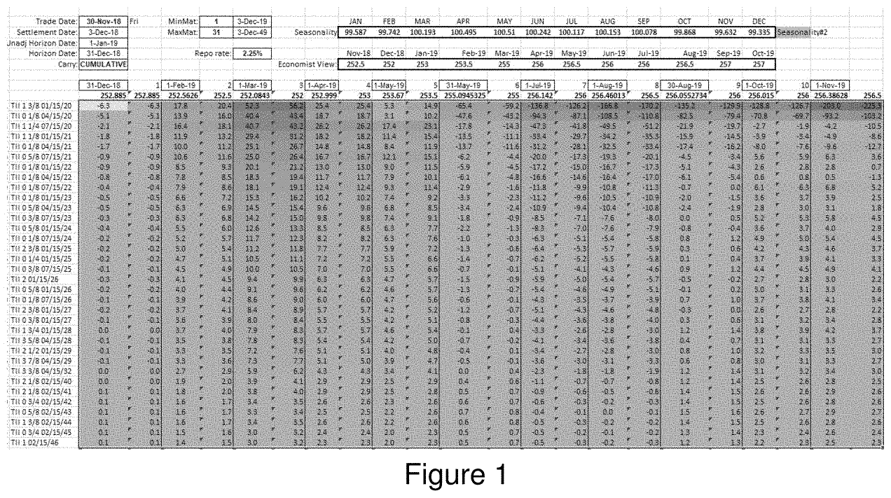

Referring now to FIG. 1, we see a heatmap for carry, which however fails to convey seasonality information well. The reason the heatmap fails to convey the information well is that shorter-maturity bonds have a much more pronounced seasonal carry.

For example, a ten-year bond (the April 15's of 2028) sees its cumulative seasonal carry vary between a minimum of −4.1 in on July 1^{st} and a maximum of +7.8 on March 1^{st} whereas a three year bond (the April 15's of 2021) sees its seasonal carry vary between −32.5 on August 1^{st} and +25.1 on March 1^{st}. On the heatmap, because it deals in absolutes, the colors fail to align in the same way for those two bonds.

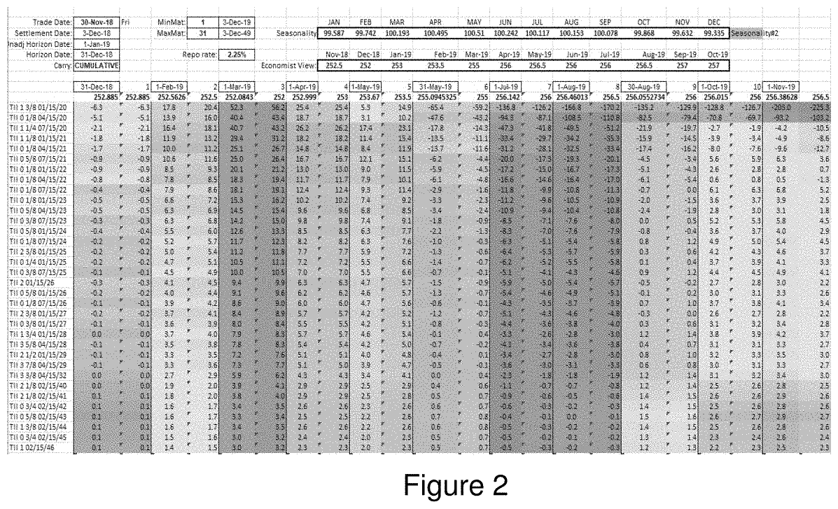

In FIG. 2, the heatmap has been adjusted to reflect relative carry on a row by row basis. In effect, every single row is its own heatmap. From the display of FIG. 2, one can clearly see that there are seasons, but it is difficult to move one's eyes from left to right to analyze the data, e.g., along a particular row.

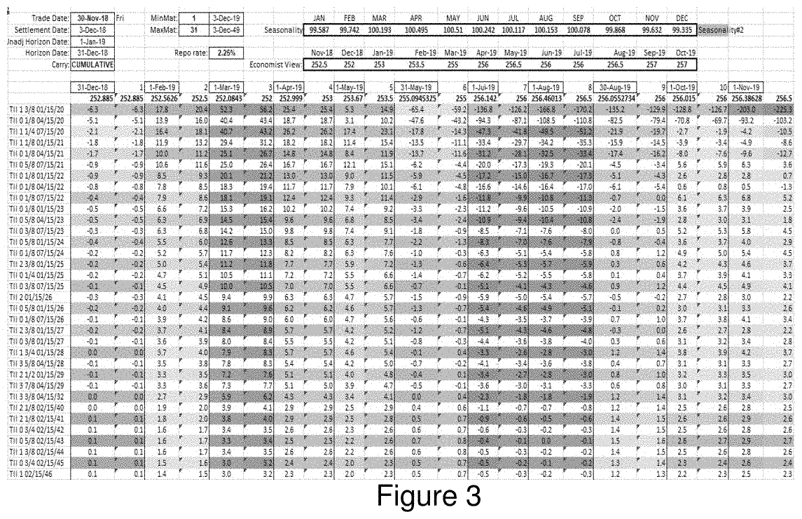

In FIG. 3, this left to right scanning issue is resolved by providing alternating lines of a contrasting color, in this case white. While the “temperature” of the alternate rows is not displayed, the eye integrates this out so that virtually no information is lost, but the data is easier to read and analyze.

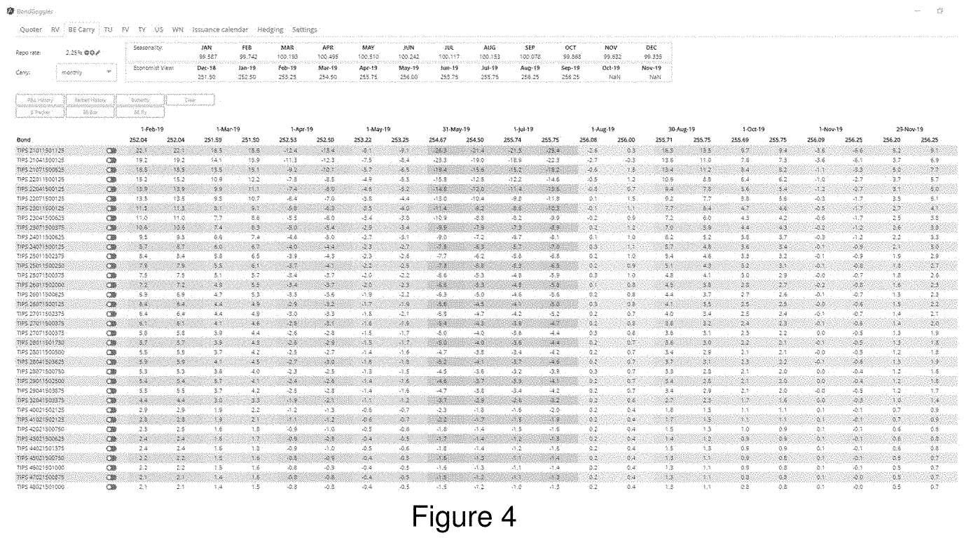

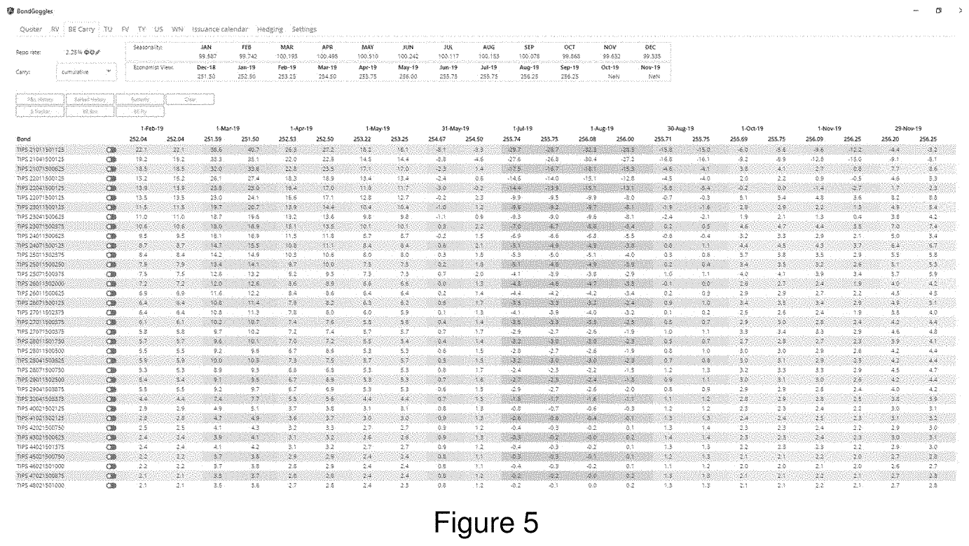

FIGS. 4 and 5 show monthly and cumulative carry tables. As noted above, each cell in the table can hold one value, two values or more than two values for the carry, whether it is monthly or cumulative. The values come from alternative inflation estimates from different sources other than the government. The cumulative carry table has the numbers from the table of FIG. 4 added up and tells the user when to strike if the user wants to play the carry season.

The computer systems discussed above can also include a computer-readable storage media reader, communications devices (e.g., modems, network cards (wireless or wired), or infrared communication devices) and memory, as previously described. The computer-readable storage media reader is connectable or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or web browser. It should be appreciated that alternate embodiments may have numerous variations from that described above. For example, customized hardware also might be used, and/or particular elements might be implemented in hardware, in software (including portable software, such as applets), or in both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based upon the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

While various embodiments of the present disclosure have been described above, it should be understood that they have been presented by way of example only, and not of limitation Likewise, the various diagrams may depict an example or other configuration for the disclosure, which is done to aid in understanding the features and functionality that can be included in the disclosure. The disclosure is not restricted to the illustrated example configurations, but the desired features can be implemented using a variety of alternative configurations. Indeed, it will be apparent to one of skill in the art how alternative functional, logical, or physical partitioning and configurations can be implemented to implement the desired features of the present disclosure. Additionally, with regard to operational descriptions and method claims, the order in which the steps are presented herein shall not mandate that the steps of the various embodiments be implemented in the order presented, unless the context dictates otherwise.

Although the disclosure is described above in terms of various example embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosure, whether or not such embodiments are described, and whether or not such features are presented as being a part of a described embodiment. Thus, the breadth and scope of the present disclosure should not be limited by any of the above-described example embodiments, and it will be understood by those skilled in the art that various changes and modifications to the previous descriptions may be made within the scope of the claims.

What is claimed is:

1. A method for displaying a heat map of the seasonal breakeven inflation carry of inflation protected bonds comprising the steps of: providing a spreadsheet of columns of carry values which have been seasonally adjusted according to the expected Consumer Price Index for rows of inflation protected bonds of different maturity dates; assigning color gradations within a first spectrum of colors to the carry values on a row by row basis for each bond; and providing a first color to alternate rows, wherein the first color is in contrast to the colors of the first spectrum of colors.

2. The method according to claim 1, wherein the spreadsheet includes at least one entry in each column for each bond and wherein the at least one entry includes breakeven inflation carry estimates based on expected inflation estimates and which are in turn based on government generated inflation seasonality estimates.

3. The method according to claim 1, wherein the spreadsheet includes at least two entries in each column for each bond and wherein one of the entries is breakeven inflation carry estimates based on expected inflation estimates and which are in turn based on government generated inflation seasonality estimates and another entry is calculated using an alternative inflation estimate.

4. The method according to claim 2, wherein the breakeven inflation carry is a monthly carry.

5. The method according to claim 2, wherein the breakeven inflation carry is a cumulative carry.

6. The method according to claim 4, wherein the spreadsheet includes at least one entry in each column for each bond and wherein the at least one entry includes breakeven inflation carry based on an estimated CPI print estimate and which in turn are based on government generated inflation seasonality estimates.

7. The method according to claim 4, wherein the spreadsheet includes at least two entries in each column for each bond and wherein one of the entries is breakeven inflation carry based on CPI estimates and which in turn are based on government generated inflation seasonality estimates and another entry is calculated using an alternative inflation estimate.

8. The method according to claim 5, wherein the spreadsheet includes at least one entry in each column for each bond and wherein the at least one entry is based on CPI estimates and which are in turn are based on government generated inflation seasonality estimates.

9. The method according to claim 5, wherein the spreadsheet includes at least two entries in each column for each bond and wherein one of the entries is based on CPI estimates and which are in turn are based on government generated inflation seasonality estimates and another entry is calculated using an alternative inflation estimate.

10. The method according to claim 1, wherein the first spectrum of colors ranges from green to yellow to red.

11. The method according to claim 10, wherein the first color is white.

12. The method according to claim 1, wherein the spreadsheet includes at least one entry in each column for each bond and wherein the at least one entry includes breakeven inflation carry estimates based on expected inflation estimates and which are in turn based on a privately generated inflation seasonality estimates.

13. The method according to claim 1, wherein the spreadsheet includes at least two entries in each column for each bond and wherein at least one of the entries is breakeven inflation carry estimates based on expected inflation estimates and which are in turn based on privately generated inflation seasonality estimates.
